(19) United States
(12) Patent Application Publication
(10) Pub. No.: US 2025/0365044 A1
(43) Pub. Date: Nov. 27, 2025

(54) ORBITAL ANGULAR MOMENTUM DATA CHANNELS CONFIGURATION

(71) Applicant: LENOVO (SINGAPORE) PTE. LTD., Singapore (SG)

(72) Inventors: Sher Ali Cheema, Ilmenau (DE); Ali Ramadan Ali, Kraiburg (DE); Seyedomid Taghizadeh Motlagh, Oberursel (DE)

(73) Assignee: Lenovo (Singapore) Pte. Limited, Singapore (SG)

(21) Appl. No.: 18/865,064

(22) PCT Filed: May 9, 2023
(86) PCT No.: PCT/IB2023/054803

§ 371 Date: Nov. 12, 2024

Related U.S. Application Data
(60) Provisional application No. 63/341,596, filed on May 13, 2022.

(51) Int. Cl. H04B 7/06; H04W 16/28; H04W 72/231; H04W 76/20

(52) U.S. Cl. CPC H04B 7/0617; H04W 16/28; H04W 72/231; H04W 76/20

(57) ABSTRACT

Various aspects of the present disclosure relate to a user equipment (UE) that receives, from a base station, a signaling indicating an orthogonal angular momentum (OAM) multiplexing configuration of one or more configured OAM modes. The UE can apply at least one of the configured OAM modes for receiving a downlink transmission and/or transmitting an uplink transmission. The base station transmits the OAM multiplexing configuration of the one or more configured OAM modes to be applied at the UE, and the base station can then receive, from the UE, an uplink transmission with at least one of the configured OAM modes applied.

### RELATED APPLICATION

This application claims priority to U.S. Provisional Application Ser. No. 63/341,596 filed May 13, 2022 entitled “Orbital Angular Momentum Data Channels Configuration,” the disclosure of which is incorporated by reference herein in its entirety.

### TECHNICAL FIELD

The present disclosure relates to wireless communications, and more specifically to orbital angular momentum (OAM).

### BACKGROUND

A wireless communications system may include one or multiple network communication devices, such as base stations, which may be otherwise known as an eNodeB (eNB), a next-generation NodeB (gNB), core network functions (CNFs), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, such as time resources (e.g., symbols, slots, subslots, mini-slots, aggregated slots, subframes, frames, or the like) or frequency resources (e.g., subcarriers, carriers). Additionally, the wireless communications system may support wireless communications across various radio access technologies (RATs) including third generation (3G) RAT, fourth generation (4G) RAT, fifth generation (5G) RAT, and other suitable RATs beyond 5G. In some cases, a wireless communications system may be a non-terrestrial network (NTN), which may support various communication devices for wireless communications in the NTN. For example, an NTN may include network entities onboard non-terrestrial vehicles such as satellites, unmanned aerial vehicles (UAV), and high-altitude platforms systems (HAPS), as well as network entities on the ground, such as gateway entities capable of transmitting and receiving over long distances.

In wireless communications, different resource domains are available for transmitting and receiving wireless signals. For instance, resources in the time domain and frequency domain can be utilized by UEs and network devices for wireless transmission and reception. The demands of higher transmission rates for wireless communications continues to increase, such as to meet the future requirements of 6G systems with modulation and multiplexing techniques.

### SUMMARY

The present disclosure relates to methods, apparatuses, and systems that support OAM data channels configuration. By utilizing the described techniques, communication devices in a wireless communications system can utilize OAM for wireless transmission and reception. Aspects of the disclosure are directed to how a data channel can be mapped to one or more configured OAM modes, including using spatial multiplexing and the application of spatial diversity techniques. The described signaling procedures include techniques for an association of data channels, downlink (DL) and uplink (UL), multiplexed with OAM modes and corresponding configuration indications provided to a UE. Additionally, the techniques include configuration of diversity or spatial multiplexing schemes coupled with OAM modes, a mapping and indication of transmission configuration indicator (TCI) states and/or QCL assumptions with OAM modes for data transmission and reception, and a configuration to apply OAM-multiple input multiple output (MIMO) multiplexing with multiple antenna arrays generating OAM modes in parallel.

Some implementations of the method and apparatuses described herein may include wireless communication at a device (e.g., a UE), and the device receives from a base station, a signaling indicating an OAM multiplexing configuration of one or more configured OAM modes. The device can apply at least one of the configured OAM modes for receiving a downlink transmission and/or transmitting an uplink transmission.

In some implementations of the method and apparatuses described herein, the device can map a configured OAM mode with at least one TCI for receiving the downlink transmission and/or transmitting the uplink transmission. The device can apply a first configured OAM mode for receiving the downlink transmission, and apply a second configured OAM mode for transmitting the uplink transmission. A number of the one or more configured OAM modes is indicated by downlink control information (DCI) signaling and/or radio resource control (RRC) signaling. The OAM multiplexing configuration includes a number of channel layers mapped to a number of codewords for spatial multiplexing, and the number of channel layers for each codeword is at least equal to a number of the one or more configured OAM modes. The number of channel layers indicates the number of the one or more configured OAM modes for receiving the downlink transmission. The number of channel layers indicates the number of the one or more configured OAM modes for transmitting the uplink transmission. The signaling indicating the OAM multiplexing configuration includes a mapping matrix that maps a number of channel layers to the one or more configured OAM modes associated with utilizing spatial multiplexing. An index associated with the mapping matrix is indicated by DCI signaling, medium access control element (MAC CE) signaling, and/or RRC signaling. The signaling indicating the OAM multiplexing configuration includes a mapping matrix that maps a number of channel layers to the one or more configured OAM modes associated with utilizing a diversity scheme.

An index associated with the mapping matrix is indicated by DCI signaling, MAC CE signaling, and/or RRC signaling. The number of TCI states corresponds to a number of the one or more configured OAM modes. The number of the one or more configured OAM modes corresponds to one TCI state. The signaling indicating the OAM multiplexing configuration includes a number of the one or more configured OAM modes associated with respective TCI states that correspond to a set of antenna arrays. A number of the TCI states indicates a number of the antenna arrays in the set of antenna arrays used for a same configured OAM mode indices generation. The signaling indicating the OAM multiplexing configuration indicates a set of OAM mode indices that is applicable to the TCI states. The signaling indicating the OAM multiplexing configuration indicates different sets of OAM mode indices applicable for the TCI states. The signaling indicating the OAM multiplexing configuration includes a set of the one or more configured OAM modes, a set of the TCI states, and an indication of rank-two transmission for receiving the downlink transmission and/or transmitting the uplink transmission. The signaling indicating the OAM multiplexing configuration includes an association of demodulation reference signal (DM-RS) ports with the one or more configured OAM modes.

Some implementations of the method and apparatuses described herein may include wireless communication at a device (e.g., a base station, gNB), and the device transmits, to a UE, a signaling indicating an OAM multiplexing configuration of one or more configured OAM modes to be applied at the UE for receiving a downlink transmission and/or transmitting an uplink transmission. The device can receive, from the UE, an uplink transmission with at least one of the one or more configured OAM modes applied.

In some implementations of the method and apparatuses described herein, the signaling is transmitted to the UE to map a configured OAM mode with a TCI for receiving the downlink transmission and/or transmitting the uplink transmission. A number of the one or more configured OAM modes is indicated by DCI signaling and/or RRC signaling. The OAM multiplexing configuration includes a number of channel layers mapped to a number of codewords for spatial multiplexing, and the number of channel layers for each codeword is at least equal to a number of the one or more configured OAM modes. The number of channel layers indicates the number of the one or more configured OAM modes for the UE receiving the downlink transmission. The number of channel layers indicates the number of the one or more configured OAM modes for the UE transmitting the uplink transmission. The signaling indicating the OAM multiplexing configuration includes a mapping matrix that maps a number of channel layers to the one or more configured OAM modes associated with utilizing spatial multiplexing. The index associated with the mapping matrix is indicated by DCI signaling, MAC CE signaling, and/or RRC signaling. The signaling indicating the OAM multiplexing configuration includes a mapping matrix that maps a number of channel layers to the one or more configured OAM modes associated with utilizing a diversity scheme.

An index associated with the mapping matrix is indicated by DCI signaling, MAC CE signaling, or RRC signaling. A number of TCI states corresponds to a number of the one or more configured OAM modes. A number of the one or more configured OAM modes corresponds to one TCI state. The signaling indicating the OAM multiplexing configuration includes a number of the one or more configured OAM modes associated with respective TCI states that correspond to a set of antenna arrays. A number of the TCI states indicates a number of the antenna arrays in the set of antenna arrays used for a same configured OAM mode indices generation. The signaling indicating the OAM multiplexing configuration indicates a set of OAM mode indices that is applicable to the TCI states. The signaling indicating the OAM multiplexing configuration indicates different sets of OAM mode indices applicable for the TCI states. The signaling indicating the OAM multiplexing configuration includes a set of the one or more configured OAM modes, a set of the TCI states, and an indication of rank-two transmission for the UE receiving the downlink transmission and/or the UE transmitting the uplink transmission. The signaling indicating the OAM multiplexing configuration includes an association of DM-RS ports with the one or more configured OAM modes.

### BRIEF DESCRIPTION OF THE DRAWINGS

Various aspects of the present disclosure for OAM data channels configuration are described with reference to the following Figures. The same numbers may be used throughout to reference like features and components shown in the Figures.

FIG. 1 illustrates an example of a wireless communications system that supports OAM data channels configuration in accordance with aspects of the present disclosure.

FIG. 2 illustrates an example of OAM modes of an OAM wave, as related to OAM data channels configuration in accordance with aspects of the present disclosure.

FIG. 3 illustrates an example of antenna phases and generation of OAM modes, as related to OAM data channels configuration in accordance with aspects of the present disclosure.

FIG. 4 illustrates an example of multiple OAM mode generation implemented with multiple uniform circular arrays, as related to OAM data channels configuration in accordance with aspects of the present disclosure.

FIG. 5 illustrates an example of streams generation corresponding to OAM modes for an UCA array that supports OAM data channels configuration in accordance with aspects of the present disclosure.

FIG. 6 illustrates an example block diagram of components of a device (e.g., a UE) that supports OAM data channels configuration in accordance with aspects of the present disclosure.

FIG. 7 illustrates an example block diagram of components of a device (e.g., a base station) that supports OAM data channels configuration in accordance with aspects of the present disclosure.

FIGS. 8-10 illustrate flowcharts of methods that support OAM data channels configuration in accordance with aspects of the present disclosure.

### DETAILED DESCRIPTION

Implementations of OAM data channels configuration are described, such as related to communication devices in a wireless communications system. The described techniques enable OAM modes that can be utilized for wireless communications, which can increase the number of available communication channels in the wireless communications system. The demands of higher transmission rates for wireless communication continues to increase, such as to meet the requirements of 6G systems with modulation and multiplexing techniques, which includes techniques that utilize OAM. The described OAM multiplexing techniques exploit the physical property of electro-magnetic waves characterized by a helical phase front in the propagation direction. In OAM, different orthogonal modes (helical phase fronts) can be generated in an angular domain, while utilizing the same frequency and time resources, thus providing an extra dimension in which to multiplex data.

Based on the transmit and receive antenna characteristics of a UE, the UE may receive multiple data streams corresponding to multiple OAM modes using the same time, frequency, space, power, and/or code resources, where each OAM mode may have different channel fading effects depending on the environment. Additionally, multiple uniform circular arrays may be used in parallel to benefit the gains for OAM and MIMO. For data channels multiplexed with OAM, techniques include a new mapping of a data channel and associated reference signals in the transmission chain, as well as the relationship with spatial beams, and this information may be indicated to UEs. In this disclosure, techniques are described for the mapping of a data channel to OAM modes, as well as the associated relationship with spatial streams, and corresponding configuration methods.

Aspects of the disclosure are directed to how a data channel can be mapped to one or more configured OAM modes, including using spatial multiplexing and the application of spatial diversity techniques. The described signaling procedures include techniques for an association of data channels (DL and UL) multiplexed with OAM modes and corresponding configuration indications provided to a UE. Additionally, the techniques include configuration of diversity or spatial multiplexing schemes coupled with OAM modes, a mapping and indication of TCI states and/or QCL assumptions with OAM modes for data transmission and reception, and a configuration to apply OAM-MIMO multiplexing with multiple antenna arrays generating OAM modes in parallel.

Aspects of the present disclosure are described in the context of a wireless communications system. Aspects of the present disclosure are further illustrated and described with reference to device diagrams and flowcharts that relate to OAM data channels configuration.

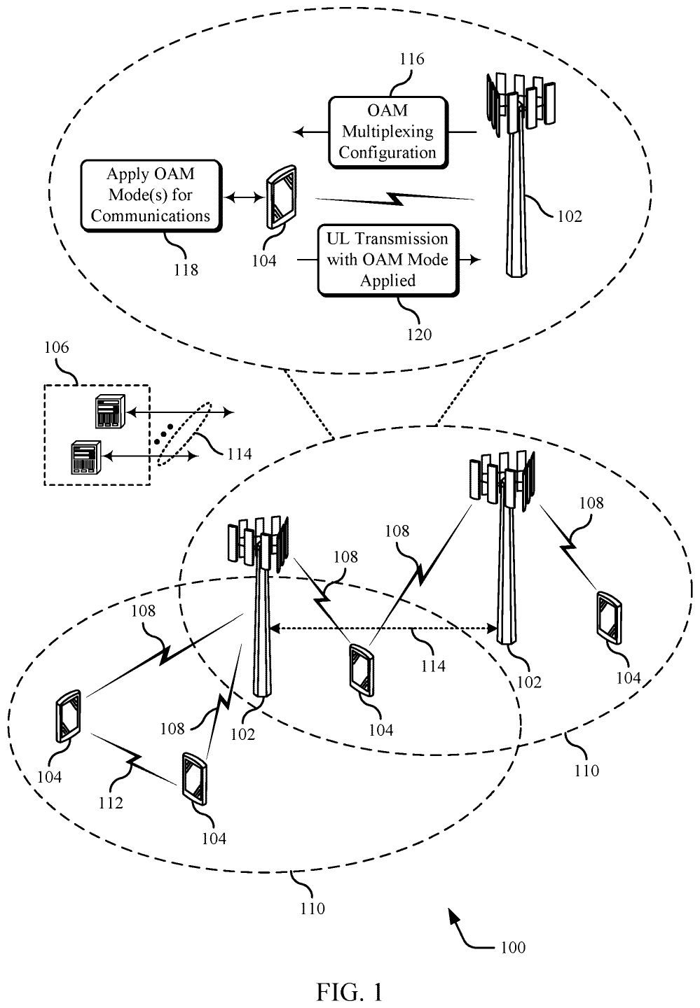

FIG. 1 illustrates an example of a wireless communications system 100 that supports OAM data channels configuration in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, or include, or may be referred to as a base transceiver station, an access point, a NodeB, an eNodeB (eNB), a next-generation NodeB (gNB), a Radio Head (RH), a relay node, an integrated access and backhaul (IAB) node, or other suitable terminology. A base station 102 and a UE 104 may communicate via a communication link 108, which may be a wireless or wired connection. For example, a base station 102 and a UE 104 may perform wireless communication over a NR-Uu interface.

A base station 102 may provide a geographic coverage area 110 for which the base station 102 may support services (e.g., voice, video, packet data, messaging, broadcast, etc.) for one or more UEs 104 within the geographic coverage area. For example, a base station 102 and a UE 104 may support wireless communication of signals related to services (e.g., voice, video, packet data, messaging, broadcast, etc.) according to one or multiple radio access technologies. In some implementations, a base station 102 may be moveable, such as when implemented as a gNB onboard a satellite or other non-terrestrial station (NTS) associated with a non-terrestrial network (NTN). In some implementations, different geographic coverage areas 110 associated with the same or different radio access technologies may overlap, and different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region or coverage area 110 of the wireless communications system 100. A UE 104 may include or may be referred to as a mobile device, a wireless device, a remote device, a handheld device, a customer premise equipment (CPE), a subscriber device, or as some other suitable terminology. In some implementations, the UE 104 may be referred to as a unit, a station, a terminal, or a client, among other examples. Additionally, or alternatively, a UE 104 may be referred to as an Internet-of-Things (IoT) device, an Internet-of-Everything (IoE) device, or as a machine-type communication (MTC) device, among other examples. In some implementations, a UE 104 may be stationary in the wireless communications system 100. In other implementations, a UE 104 may be mobile in the wireless communications system 100, such as an earth station in motion (ESIM).

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, a gateway device, an integrated access and backhaul (IAB) node, a location server that implements the location management function (LMF), or other network equipment). Additionally, or alternatively, a UE 104 may support communication with other base stations 102 or UEs 104, which may act as relays in the wireless communications system 100.

A UE 104 may also support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or other network interface). The base stations 102 may communicate with each other over the backhaul links 118 (e.g., via an X2, Xn, or another network interface). In some implementations, the base stations 102 may communicate with each other directly (e.g., between the base stations 102). In some other implementations, the base stations 102 may communicate with each other indirectly (e.g., via the core network 106). In some implementations, one or more base stations 102 may include subcomponents, such as an access network entity, which may be an example of an access node controller (ANC). The ANC may communicate with the one or more UEs 104 through one or more other access network transmission entities, which may be referred to as remote radio heads, smart radio heads, gateways, transmission-reception points (TRPs), and other network nodes and/or entities.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)), and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

According to implementations, one or more of the UEs 104 and base stations 102 are operable to implement various aspects of OAM data channels configuration, as described herein. For instance, a base station 102 can communicate an OAM multiplexing configuration 116 that includes one or more configured OAM modes to be applied at the UE 104 for receiving a downlink transmission and/or transmitting an uplink transmission. The UE 104 receives the OAM multiplexing configuration 116 of one or more configured OAM modes, and can apply the configured OAM modes at 118 for wireless communications with network devices, such as for receiving downlink transmission(s) and/or for transmitting uplink transmission(s). The base station 102 can also receive, from the UE 104, an uplink transmission 120 with a configured OAM mode applied.

In aspects of OAM data channels configuration, and with reference to a physical downlink shared channel (PDSCH) and layer mapping, a UE shall assume that complex-valued modulation symbols for each of the codewords to be transmitted are mapped onto one or several layers, according to Table 7.3.1.3-1 below for codeword-to-layer mapping for spatial multiplexing. Complex-valued modulation symbols

$${d}^{( q )} ( 0 ) , … , {d}^{( q )} ( {M}_{symb}^{( q )} - 1 )$$

for codeword q shall be mapped onto the layers

$$x ( i ) = {[ {x}^{( 0 )} ( i ) … {x}^{( υ - 1 )} ( i ) ]}^{T} , i = 0 , 1 , … , {M}_{symb}^{layer} - 1$$

where v is the number of layers and

$${M}_{symb}^{layer}$$

is the number of modulation symbols per layer.

TABLE 7.3.1.3-1
Codeword-to-layer mapping for spatial multiplexing:

| | | Codeword-to-layer mapping | |
|---|---|---|---|
| Number of layers | Number of codewords | $i = 0 , 1 , … , {M}_{symb}^{layer} - 1$ | |
| 1 | 1 | x⁽⁰⁾(i) = d⁽⁰⁾(i) | ${M}_{symb}^{layer} = {M}_{symb}^{( 0 )}$ |
| 2 | 1 | x⁽⁰⁾(i) = d⁽⁰⁾(2i) x⁽¹⁾(i) = d⁽⁰⁾(2i+1) | ${M}_{s y m b}^{layer} = {M}_{s y m b}^{( 0 )} / 2$ |
| 3 | 1 | x⁽⁰⁾(i) = d⁽⁰⁾(3i) x⁽¹⁾(i) = d⁽⁰⁾(3i +1) | ${M}_{s y m b}^{layer} = {M}_{s y m b}^{( 0 )} / 3$ |
| | | x⁽²⁾(i) = d⁽⁰⁾(3i + 2) | |
| 4 | 1 | x⁽⁰⁾(i) = d⁽⁰⁾(4i) x⁽¹⁾(i) = d⁽⁰⁾(4i +1) | ${M}_{s y m b}^{layer} = {M}_{s y m b}^{( 0 )} / 4$ |
| | | x⁽²⁾(i) = d⁽⁰⁾(4i + 2) | |
| | | x⁽³⁾(i) = d⁽⁰⁾(4i + 3) | |
| 5 | 2 | x⁽⁰⁾(i) = d⁽⁰⁾(2i) x⁽¹⁾(i) = d⁽⁰⁾(2i+1) | ${M}_{s y m b}^{layer} = {M}_{s y m b}^{( 0 )} / 2 = {M}_{s y m b}^{( 1 )} / 3$ |
| | | x⁽²⁾(i) = d⁽¹⁾(3i) | |
| | | x⁽³⁾(i) = d⁽¹⁾(3i +1) | |
| | | x⁽⁴⁾(i) = d⁽¹⁾(3i + 2) | |
| 6 | 2 | x⁽⁰⁾(i) = d⁽⁰⁾(3i) x⁽¹⁾(i) = d⁽⁰⁾(3i+1) | ${M}_{s y m b}^{layer} = {M}_{s y m b}^{( 0 )} / 3 = {M}_{s y m b}^{( 1 )} / 3$ |
| | | x⁽²⁾(i) = d⁽⁰⁾(3i + 2) | |
| | | x⁽³⁾(i) = d⁽¹⁾(3i) | |
| | | x⁽⁴⁾(i) = d⁽¹⁾(3i+1) | |
| | | x⁽⁵⁾(i) = d⁽¹⁾ (3i + 2) | |
| 7 | 2 | x⁽⁰⁾(i) = d⁽⁰⁾(3i) x⁽¹⁾(i) = d⁽⁰⁾(3i+1) | ${M}_{s y m b}^{layer} = {M}_{s y m b}^{( 0 )} / 3 = {M}_{s y m b}^{( 1 )} / 4$ |
| | | x⁽²⁾(i) = d⁽⁰⁾(3i + 2) | |
| | | x⁽³⁾(i) = d⁽¹⁾(4i) | |
| | | x⁽⁴⁾(i) = d⁽¹⁾(4i + 1) | |
| | | x⁽⁵⁾(i) = d⁽¹⁾(4i + 2) | |
| | | x⁽⁶⁾(i) = d⁽¹⁾(4i + 3) | |
| 8 | 2 | x⁽⁰⁾(i) = d⁽⁰⁾(4i) x⁽¹⁾(i) = d⁽⁰⁾(4i+1) | ${M}_{s y m b}^{layer} = {M}_{s y m b}^{( 0 )} / 4 = {M}_{s y m b}^{( 1 )} / 4$ |
| | | x⁽²⁾(i) = d⁽⁰⁾(4i+2) | |
| | | x⁽³⁾(i) = d⁽⁰⁾(4i + 3) | |
| | | x⁽⁴⁾(i) = d⁽¹⁾(4i) | |
| | | x⁽⁵⁾(i) = d⁽¹⁾(4i + 1) | |
| | | x⁽⁶⁾(i) = d⁽¹⁾(4i + 2) | |
| | | x⁽⁷⁾(i) = d⁽¹⁾(4i + 3) | |

With respect to antenna port mapping, the block of vectors [x⁽⁰⁾(i) . . . x^{(v-1)}(i)]^{T} ,

$$i = 0 , 1 , … , {M}_{symb}^{layer} - 1$$

shall be mapped to antenna ports according to:

$$[ \begin{matrix}\begin{matrix}{y}^{( {p}_{0} )} ( i ) \\ ⋮\end{matrix} \\ {y}^{( {p}_{υ - 1} )} ( i )\end{matrix} ] = [ \begin{matrix}\begin{matrix}{x}^{( 0 )} ( i ) \\ ⋮\end{matrix} \\ {x}^{( υ - 1 )} ( i )\end{matrix} ]$$

where

$$i = 0 , 1 , … , {M}_{symb}^{ap} - 1 , {M}_{symb}^{ap} = {M}_{symb}^{layer} ,$$

and the set of antenna ports {P₀, . . . , P_{υ-1}} are determined according to a procedure [4, TS 38.212].

With reference to mapping to virtual resource blocks, a UE shall, for each of the antenna ports used for transmission of the physical channel, assume the block of complex-valued symbols

$${y}^{( p )} ( 0 ) , … , {y}^{( p )} ( {M}_{symb}^{ap} - 1 )$$

conform to the downlink power allocation specified in [6, TS 38.214] and are mapped in sequence starting with y^{(p)}(0) to resource elements (k′, l)_{p,u} in the virtual resource blocks assigned for transmission which meet all of the following criteria: they are in the virtual resource blocks assigned for transmission; the corresponding physical resource blocks are declared as available for PDSCH (according to clause 5.1.4 of [6, TS 38.214]); and the corresponding resource elements in the corresponding physical resource blocks are: not used for transmission of the associated DM-RS or DM-RS intended for other co-scheduled UEs (as described in clause 7.4.1.1.2); not used for non-zero-power channel state information (CSI)-RS (according to clause 7.4.1.5) if the corresponding physical resource blocks are for PDSCH scheduled by physical downlink control channel (PDCCH) with cyclic redundancy check (CRC) scrambled by C-radio network temporary identifier (RNTI), MCS-C-RNTI, CS-RNTI, or PDSCH with semi-persistent scheduling (SPS), except if the non-zero-power CSI-RS is a CSI-RS configured by the higher-layer parameter CSI-RS-Resource-Mobility in the MeasObjectNR information element ((I.E.,) or except if the non-zero-power CSI-RS is an aperiodic non-zero-power CSI-RS resource; not used for phase tracking reference signal (PT-RS) (according to clause 7.4.1.2); not declared as not available for PDSCH (according to clause 5.1.4 of [6, TS 38.214]).

The mapping to resource elements (k′, l)_{p,u} allocated for PDSCH (according to [6, TS 38.214]) and not reserved for other purposes shall be in increasing order of first the index k′ over the assigned virtual resource blocks, where k′=0 is the first subcarrier in the lowest-numbered virtual resource block assigned for transmission, and then the index l. With respect to mapping from virtual to physical resource blocks, a UE shall assume the virtual resource blocks are mapped to physical resource blocks according to the indicated mapping scheme, non-interleaved or interleaved mapping. If no mapping scheme is indicated, the UE shall assume non-interleaved mapping. For non-interleaved virtual resource block (VRB)-to-physical resource block (PRB) mapping, virtual resource block n is mapped to physical resource block n, except for PDSCH transmissions scheduled with DCI format 1_0 in a common search space in which case virtual resource block n is mapped to physical resource block

$$n + {N}_{start}^{CORESET}$$

where

$${N}_{start}^{CORESET}$$

is the lowest-numbered physical resource block in the control resource set where the corresponding DCI was received.

For interleaved VRB-to-PRB mapping, the mapping process is defined by resource block bundles and virtual resource blocks. The resource block bundles are defined as follows. For PDSCH transmissions scheduled with DCI format 1_0 with the CRC scrambled by SI-RNTI in Type0-PDCCH common search space in control resource set (CORESET) 0, the set of

$${N}_{BWP , init}^{size}$$

resource blocks in CORESET 0 are divided into

$${N}_{bundle} = ⌈ {N}_{BWP , init}^{size} / L ⌉$$

resource-block bundles in increasing order of the resource-block number and bundle number where L=2 is the bundle size and

$${N}_{BWP , init}^{size}$$

is the size of CORESET 0. Resource block bundle N_{bundle}−1 consists of

$${N}_{BWP , init}^{size} mod L$$

resource blocks if

$${N}_{BWP , init}^{size} mod L > 0$$

and L resource blocks otherwise, all other resource block bundles consists of L resource blocks. For PDSCH transmissions scheduled with DCI format 1_0 in any common search space in bandwith part i with starting position

$${N}_{BWP , i}^{size} ,$$

other than Type0-PDCCH common search space in CORESET 0, the set of

$${N}_{BWP , init}^{size}$$

virtual resource blocks

$$\{ 0 , 1 , … , {N}_{BWP , init}^{size} - 1 \} ,$$

where

$${N}_{BWP , init}^{size}$$

is the size of CORESET 0 if CORESET 0 is configured for the cell and the size of the initial downlink bandwidth part if CORESET 0 is not configured for the cell, are divided into N_{bundle} virtual resource-block bundles in increasing order of the virtual resource-block number and virtual bundle number and the set of

$${N}_{BWP , init}^{size}$$

physical resource block

$$\{ {N}_{start}^{CORESET} , {N}_{start}^{CORESET} + 1 , … , {N}_{start}^{CORESET} + {N}_{BWP , init}^{size} - 1 \}$$

are divided into N_{bundle} physical resource-block bundles in increasing order of the physical resource-block number and physical bundle number, where

$${N}_{bundle} = ⌈ ( {N}_{BWP , init}^{size} + ( {N}_{BWP , i}^{start} + {N}_{start}^{CORESET} ) mod L ) / L ⌉ , L = 2$$

is the bundle size, and

$${N}_{s t a r t}^{C O R E S E T}$$

is the lowest-numbered physical resource block in the control resource set where the corresponding DCI was received.

The resource block bundle 0 consists of

$$L - ( ( {N}_{BWP , i}^{s t a r t} + {N}_{s t a r t}^{C O R E S E T} ) mod L$$

resource blocks, resource block bundle N_{bundle}−1 consists of

$$( {N}_{BWP , init}^{size} + {N}_{BWP , i}^{s tart} + {N}_{s t a r t}^{C O R E S E T} ) mod L$$

resource blocks if

$$( {N}_{BWP , init}^{size} + {N}_{BWP , i}^{s t a r t} + {N}_{s t a r t}^{C O R E S E T} ) mod L > 0 and L$$

resource blocks otherwise, all other resource block bundles consists of L resource blocks. For all other PDSCH transmissions, the set of

$${N}_{BWP , i}^{size}$$

resource blocks in bandwidth part i with starting position

$${N}_{BWP , i}^{s t a r t}$$

are divided into

$${N}_{bundle} = ⌈ ( {N}_{BWP , i}^{size} + ( {N}_{BWP , i}^{s t a r t} mod {L}_{i} ) ) / {L}_{i} ⌉$$

resource-block bundles in increasing order of the resource-block number and bundle number where Lᵢ is the bundle size for bandwidth part i provided by the higher-layer parameter vrb-ToPRB-Interleaver, and resource block bundle 0 consists of

$${L}_{i} - ( {N}_{BWP , i}^{start} mod {L}_{i} )$$

resource blocks, resource block bundle N_{bundle}−1 consists of

$$( {N}_{B WP , i}^{start} + {N}_{BWP , i}^{s i z e} ) mod {L}_{i}$$

resource blocks if

$$( {N}_{B WP , i}^{start} + {N}_{BWP , i}^{s i z e} ) mod {L}_{i} > 0$$

and Lᵢ resource blocks otherwise, all other resource block bundles consists of Lᵢ resource blocks.

Virtual resource blocks in the interval j∈{0,1, . . . , N_{bundle}−1} are mapped to physical resource blocks according to virtual resource block bundle N_{bundle}−1 is mapped to physical resource block bundle N_{bundle}−1, virtual resource block bundle j∈{0,1, . . . , N_{bundle}−2} is mapped to physical resource block bundle f₍ⱼ₎ where: f₍ⱼ₎=rC+c; j=cR+r; r=0,1, . . . , R−1; c=0,1, . . . , C−1; R=2; C=└N_{bundle}/R┘. The UE is not expected to be configured with Lᵢ=2 simultaneously with a PRG size of four (4). The UE may assume that the same precoding in the frequency domain is used within a PRB bundle and the bundle size is determined (by clause 5.1.2.3 in [6, TS 38.214]). The UE shall not make any assumption that the same precoding is used for different bundles of common resource blocks.

With reference to antenna ports quasi co-location, a UE can be configured with a list of up to M TCI-state configurations within the higher layer parameter PDSCH-config to decode PDSCH according to a detected PDCCH with DCI intended for the UE and the given serving cell, where M depends on the UE capability maxNumberConfiguredTCIstatesPerCC. Each TCI-state contains parameters for configuring a quasi co-location relationship between one or two downlink reference signals and the DM-RS ports of the PDSCH, the DM-RS port of PDCCH, or the CSI-RS port(s) of a CSI-RS resource. The quasi co-location relationship is configured by the higher layer parameter qcl-Type1 for the first DL RS, and qcl-Type2 for the second DL RS (if configured). For the case of two DL RSs, the quasi-collocation (QCL) types shall not be the same, regardless of whether the references are to the same DL RS or different DL RSs. The quasi co-location types corresponding to each DL RS are given by the higher layer parameter qcl-Type in QCL-Info and may take one of the following values: ‘typeA’: {Doppler shift, Doppler spread, average delay, delay spread}; ‘typeB’: {Doppler shift, Doppler spread}; ‘typeC’: {Doppler shift, average delay}; or ‘typeD’: {Spatial Rx parameter}.

The UE receives an activation command used to map up to eight (8) TCI states to the codepoints of the DCI field ‘Transmission Configuration Indication’ in one control channel (CC)/DL bandwidth part (BWP) or in a set of CCs/DL BWPs, respectively. When a set of TCI state IDs are activated for a set of CCs/DL BWPs, where the applicable list of CCs is determined by indicated CC in the activation command, the same set of TCI state IDs are applied for all DL BWPs in the indicated CCs. When a UE supports two TCI states in a codepoint of the DCI field ‘Transmission Configuration Indication’, the UE may receive an activation command that is used to map up to eight (8) combinations of one or two TCI states to the codepoints of the DCI field ‘Transmission Configuration Indication’. The UE is not expected to receive more than eight (8) TCI states in the activation command. When the DCI field ‘Transmission Configuration Indication’ is present in DCI format 1_2, and when the number of codepoints S in the DCI field ‘Transmission Configuration Indication’ of DCI format 1_2 is smaller than the number of TCI codepoints that are activated by the activation command, only the first S activated codepoints are applied for DCI format 1_2.

When the UE transmits a physical uplink control channel (PUCCH) with hybrid automatic repeat request-acknowledgement (HARQ-ACK) information in slot n corresponding to the PDSCH carrying the activation command, the indicated mapping between TCI states and codepoints of the DCI field ‘Transmission Configuration Indication’ should be applied starting from the first slot that is after slot

$$n + 3 {N}_{slot}^{subframe , μ}$$

where m is the subcarrier spacing (SCS) configuration for the PUCCH. If tci-PresentInDCI is set to ‘enabled’ or tci-PresentDCI-1-2 is configured for the CORESET scheduling the PDSCH, and the time offset between the reception of the DL DCI and the corresponding PDSCH is equal to or greater than timeDurationForQCL if applicable, after a UE receives an initial higher layer configuration of TCI states and before reception of the activation command, the UE may assume that the DM-RS ports of PDSCH of a serving cell are quasi co-located with the synchronization signal (SS)/physical broadcast channel (PBCH) block determined in the initial access procedure with respect to qcl-Type set to ‘typeA’, and when applicable, also with respect to qcl-Type set to ‘typeD’.

If a UE is configured with the higher layer parameter tci-PresentInDCI that is set as ‘enabled’ for the CORESET scheduling the PDSCH, the UE assumes that the TCI field is present in the DCI format 1_1 of the PDCCH transmitted on the CORESET. If a UE is configured with the higher layer parameter tci-PresentDCI-1-2 for the CORESET scheduling the PDSCH, the UE assumes that the TCI field with a DCI field size indicated by tci-PresentDCI-1-2 is present in the DCI format 1_2 of the PDCCH transmitted on the CORESET. If the PDSCH is scheduled by a DCI format not having the TCI field present, and the time offset between the reception of the DL DCI and the corresponding PDSCH of a serving cell is equal to or greater than a threshold timeDurationForQCL if applicable, where the threshold is based on reported UE capability for determining PDSCH antenna port quasi co-location, the UE assumes that the TCI state or the QCL assumption for the PDSCH is identical to the TCI state or QCL assumption whichever is applied for the CORESET used for the PDCCH transmission within the active BWP of the serving cell.

If the PDSCH is scheduled by a DCI format having the TCI field present, the TCI field in DCI in the scheduling component carrier points to the activated TCI states in the scheduled component carrier or DL BWP, the UE shall use the TCI-state according to the value of the ‘Transmission Configuration Indication’ field in the detected PDCCH with DCI for determining PDSCH antenna port quasi co-location. The UE may assume that the DM-RS ports of PDSCH of a serving cell are quasi co-located with the RS(s) in the TCI state with respect to the QCL type parameter(s) given by the indicated TCI state if the time offset between the reception of the DL DCI and the corresponding PDSCH is equal to or greater than a threshold timeDurationForQCL, where the threshold is based on reported UE capability. When the UE is configured with a single slot PDSCH, the indicated TCI state should be based on the activated TCI states in the slot with the scheduled PDSCH.

When the UE is configured with a multi-slot PDSCH, the indicated TCI state should be based on the activated TCI states in the first slot with the scheduled PDSCH, and the UE shall expect the activated TCI states are the same across the slots with the scheduled PDSCH. When the UE is configured with CORESET associated with a search space set for cross-carrier scheduling and the UE is not configured with enableDefaultBeamForCCS, the UE expects tci-PresentInDCI is set as ‘enabled’ or tci-PresentDCI-1-2 is configured for the CORESET, and if one or more of the TCI states configured for the serving cell scheduled by the search space set contains qcl-Type set to ‘typeD’, the UE expects the time offset between the reception of the detected PDCCH in the search space set and the corresponding PDSCH is larger than or equal to the threshold timeDurationForQCL.

Independent of the configuration of tci-PresentInDCI and tci-PresentDCI-1-2 in radio resource control (RRC) connected mode, if the offset between the reception of the DL DCI and the corresponding PDSCH is less than the threshold timeDurationForQCL and at least one configured TCI state for the serving cell of scheduled PDSCH contains qcl-Type set to ‘typeD’, then the UE may assume that the DM-RS ports of PDSCH of a serving cell are quasi co-located with the RS(s) with respect to the QCL parameter(s) used for PDCCH quasi co-location indication of the CORESET associated with a monitored search space with the lowest controlResourceSetId in the latest slot in which one or more CORESETs within the active BWP of the serving cell are monitored by the UE. In this case, if the qcl-Type is set to ‘typeD’ of the PDSCH DM-RS is different from that of the PDCCH DM-RS with which they overlap in at least one symbol, the UE is expected to prioritize the reception of PDCCH associated with that CORESET. This also applies to the intra-band carrier aggregation (CA) case (when PDSCH and the CORESET are in different component carriers).

If a UE is configured with enableDefaultTCIStatePerCoresetPoolIndex and the UE is configured by higher layer parameter PDCCH-Config that contains two different values of coresetPoolIndex in different ControlResourceSets, the UE may assume that the DM-RS ports of PDSCH associated with a value of coresetPoolIndex of a serving cell are quasi co-located with the RS(s) with respect to the QCL parameter(s) used for PDCCH quasi co-location indication of the CORESET associated with a monitored search space with the lowest controlResourceSetId among CORESETs, which are configured with the same value of coresetPoolIndex as the PDCCH scheduling that PDSCH, in the latest slot in which one or more CORESETs associated with the same value of coresetPoolIndex as the PDCCH scheduling that PDSCH within the active BWP of the serving cell are monitored by the UE. In this case, if the ‘QCL-TypeD’ of the PDSCH DM-RS is different from that of the PDCCH DM-RS with which they overlap in at least one symbol and they are associated with same coresetPoolIndex, the UE is expected to prioritize the reception of PDCCH associated with that CORESET. This also applies to the intra-band CA case (when PDSCH and the CORESET are in different component carriers).

If a UE is configured with enableTwoDefaultTCI-States, and at least one TCI codepoint indicates two TCI states, the UE may assume that the DM-RS ports of PDSCH or PDSCH transmission occasions of a serving cell are quasi co-located with the RS(s) with respect to the QCL parameter(s) associated with the TCI states corresponding to the lowest codepoint among the TCI codepoints containing two different TCI states. When the UE is configured by higher layer parameter repetitionScheme set to ‘tdmSchemeA’ or is configured with higher layer parameter repetitionNumber, the mapping of the TCI states to PDSCH transmission occasions is determined according to clause 5.1.2.1 by replacing the indicated TCI states with the TCI states corresponding to the lowest codepoint among the TCI codepoints containing two different TCI states based on the activated TCI states in the slot with the first PDSCH transmission occasion. In this case, if the ‘QCL-TypeD’ in both of the TCI states corresponding to the lowest codepoint among the TCI codepoints containing two different TCI states is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers). In all cases above, if none of configured TCI states for the serving cell of scheduled PDSCH is configured with qcl-Type set to ‘typeD’, the UE shall obtain the other QCL assumptions from the indicated TCI states for its scheduled PDSCH irrespective of the time offset between the reception of the DL DCI and the corresponding PDSCH.

Conventional wireless communication designs are built on the plane-electromagnetic wave. However, the electromagnetic (EM) wave possesses not only linear momentum, but also angular momentum, which contains either the spin angular momentum (SAM) or OAM. OAM is a wavefront with helical phase OAM and has a great number of topological charges, that are referred as OAM-modes. Beams with different OAM-modes are orthogonal to each other and they can be multiplexed and demultiplexed together, thus increasing the capacity without relying on the traditional resources such as time and frequency. OAM is formed by microscopic particles moving in a circle along the propagation direction, which is related to the spatial distribution of particles. It is macroscopically represented as a vortex beam carrying the wavefront phase factor exp(jlø) (where “l” is the topological charge of the wave or azimuthal order or index, or even the roll index and determines the number of OAM modes, and “ø” represents emission phase angle or roll angle).

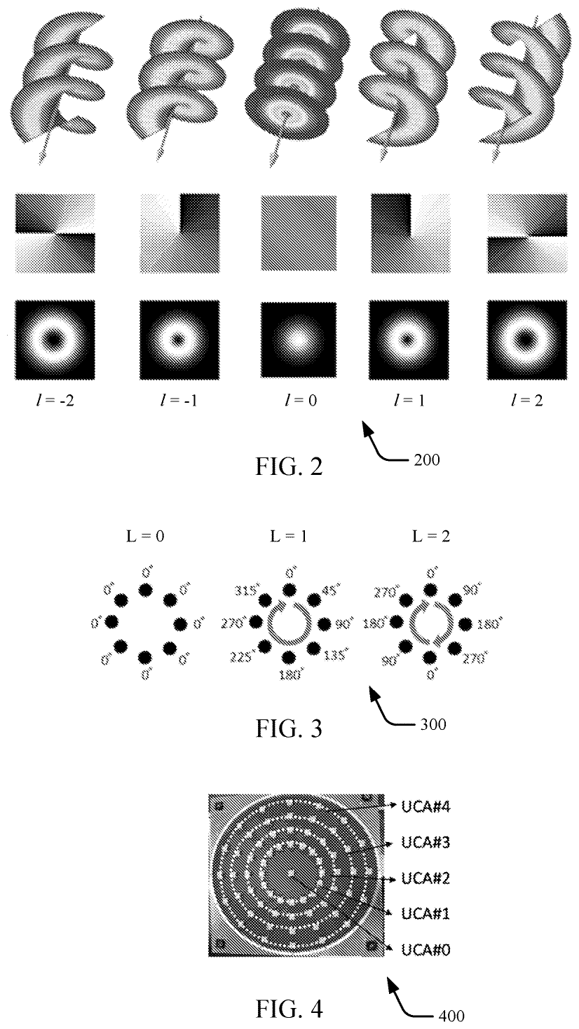

FIG. 2 illustrates an example 200 of OAM modes of an OAM wave, as related to OAM data channels configuration. FIG. 3 illustrates an example 230 of antenna phases and generation of OAM modes, as related to OAM data channels configuration. (FIG. 3 Ref: Appl. Sci. 2019, 9, 1729; doi: 10.3390/app9091729, licensed under Creative Commons BY 4.0). To generate the beam carrying an OAM mode n (L=n), antenna elements are connected with phase shifters that make n×360 degrees of rotation. The example 300 shows beam generations of OAM modes 0, 1, and 2 using uniform circular arrays (UCAs) consisting of eight (8) antenna elements.

FIG. 4 illustrates an example 400 of multiple OAM mode generation implemented with multiple uniform circular arrays, as related to OAM data channels configuration. (FIG. 4 Ref: Appl. Sci. 2019, 9, 1729; doi: 10.3390/app9091729, licensed under Creative Commons BY 4.0). Notably, it is possible to use either a single UCA or multiple UCAs for multiple OAM mode generation, as shown in the example 400. In the former case, superposed beams are transmitted by a single UCA. In the latter case, concentric multiple UCAs can be used. The separation of beams carrying OAM modes can be performed similar to generation using antenna elements connected with phase shifters that make opposite rotation directions. As long as the number of antenna elements is larger than 2 n, rotations of n×360 degrees are orthogonal to one another. Therefore, each OAM mode can be separated from mixed OAM modes' signals without aliasing. Such beam separation can also be performed by using a single UCA or multiple UCAs as in the beam generation. Note that a divider is equipped between antenna elements and phase shifters in the former case. To avoid confusion regarding the term “multiple UCAs”, this disclosure refers to superposition-based beam generation using a single UCA, as described. As illustrated in the example 400, the multiple antenna arrays can generate simultaneous, same OAM modes.

In aspects of OAM data channels configuration and the described techniques, OAM modes with different values of topological charge of the wave are mutually orthogonal, and therefore, vortex beams carrying different OAM modes can provide independent communication channels for efficient information transmission. In this disclosure, signaling aspects are related to mapping and indication of data channels that are multiplexed with OAM modes. Specifically, different codewords may be mapped and/or indicated such that diversity and spatial multiplexing schemes may be used with OAM multiplexing. Techniques are also described for configurations to indicate OAM modes when data is to be multiplexed with OAM modes, and when multiple arrays are used to generate OAM modes in parallel, thus utilizing MIMO and OAM multiplexing simultaneously.

In an implementation of OAM data channels configuration, a UE can be provided an indication, explicitly or implicitly, with at least one OAM mode index that is applied to data channels, the number of total OAM modes applied, diversity or spatial multiplexing schemes coupled with OAM modes, or a combination thereof. The OAM mode order can be infinitely increased, thus resulting in indefinite spatial multiplexing order for OAM multiplexing transmission. Depending on antenna type, multiple OAM modes may be generated simultaneously. In an implementation, the number of baseband spatial streams or RF chains correspond to the number of OAM modes, where diversity or spatial multiplexing schemes may additionally be coupled with an OAM mode number. For example, based on the CSI feedback from the UE, two mode numbers may be used for diversity and two OAM modes may be used for spatial multiplexing.

In an implementation, a one-to-one relationship between layer mapping and OAM modes may be defined and specified in the specification, where the number of layers for each codeword would at least be equal to the specified number of OAM modes. For example, if OAM is applied to a downlink system with an orthogonal frequency division multiplexing (OFDM) waveform, then the number of layers is known to the UE (i.e., from the Table 7.3.1.3-1 above) and the number of layers may be increased according to the OAM mode order (the number of OAM modes) for each of the codewords. For instance, if the OAM mode order is five, then the number of layers would increase to ten (10) (i.e., five each for a codeword) and the number of modulation symbols per layer would also be defined for the additional layer (i.e.,

$${M}_{s y m b}^{layer} = {M}_{s y m b}^{0} / 5$$

for codeword one (1) and the 5^{th} layer. In such a case, an indication of the number of layers may present the number of used modes or vice versa.

In an implementation, a mapping matrix is used in the baseband processing that maps the number of layers that correspond to transport blocks (TBs) or different code block groups or different codewords to the OAM modes, where the elements of matrix define which of the baseband spatial streams would employ which sort of diversity scheme (diversity or spatial multiplexing). For example, the block of vectors [x⁽⁰⁾(i) . . . x^{(v-1)}(i)]^{T},

$$i = 0 , 1 , … , {M}_{s y m b}^{layer} - 1$$

shall be mapped to antenna ports according to:

$$[ \begin{matrix}{y}^{( {p}_{0} )} ( i ) \\ ⋮ \\ {y}^{( {p}_{v - 1} )} ( i )\end{matrix} ] = {W}_{b} ( i ) [ \begin{matrix}{y}^{( 0 )} ( i ) \\ ⋮ \\ {y}^{( v - 1 )} ( i )\end{matrix} ] ,$$

where

$$i = 0 , 1 , … , {M}_{s y m b}^{a p} - 1 , {M}_{s y m b}^{a p} = {M}_{s y m b}^{layer} , \{ {p}_{0} , … , {p}_{v - 1} \}$$

denotes the antenna ports, and W_{b}(i) is the mapping matrix for the OAM modes. For example, if spatial multiplexing is to be applied, then there would be a one-to-one mapping of the number of layers to the antenna ports (i.e., the mapping matrix is an identity matrix). In an implementation, the number of ports may represent the OAM mode order. Different types of mapping matrices W_{b}(i) may be designed and specified in the specification and an index corresponding to a matrix may be configured either dynamically through DCI or MAC CE or higher layer signaling RRC.

In an implementation, one or multiple OAM indices are indicated for the scheduled data channels, where this indication may be dynamically configured through DCI, through MAC CE, through RRC signaling, or a combination thereof. For example, if DCI format 1_0 is used for scheduling of PDSCH in a cell, a new field is used to indicate at least one OAM mode index corresponding to the indicated modulation and coding scheme (MCS) value. The bit length depends on the number of applicable OAM modes and corresponds to a row index of a table that indicates the OAM modes values (positive and/or negative integer values). The table showing the relationship between the configured indices and OAM modes may additionally be configured through RRC signaling, as shown in Table T1, or may be pre-defined in the specifications.

TABLE T1
Configured indices for different OAM modes:

| Index | OAM mode values |
|---|---|
| 1 | −2 |
| 2 | −1 |
| 3 | 1 |
| 4 | 2 |

In an implementation, there is a one-to-one mapping of OAM modes and TCI states. For instance, a mapping table between OAM modes and TCI states may be defined, where an indication of one TCI state would indicate a predefined OAM mode. In an implementation, a TCI state can correspond to all of the OAM modes when multiple OAM modes are indicated. Alternatively, one TCI state may be indicated, and the rank greater than or equal to two (rank>=2) spatial multiplexing transmission is indicated to the UE for DL reception and/or UL transmissions. This implies that all of the indicated OAM modes use different physical downlink control channel (PDCCH) physical downlink control channel (PDCCH) TBs (or a code block group, or a codeword) that are mapped to each of the RF chain. In one or more implementations, when only one OAM mode is indicated (e.g., through DCI), whereas two or more TCI states are indicated and rank 1 diversity transmission is indicated to the UE for DL reception and/or UL transmissions, this would imply that all of the indicated beams use the same indicated OAM mode and the same TB (or a code block group, or a codeword) is mapped to all of the configured beams.

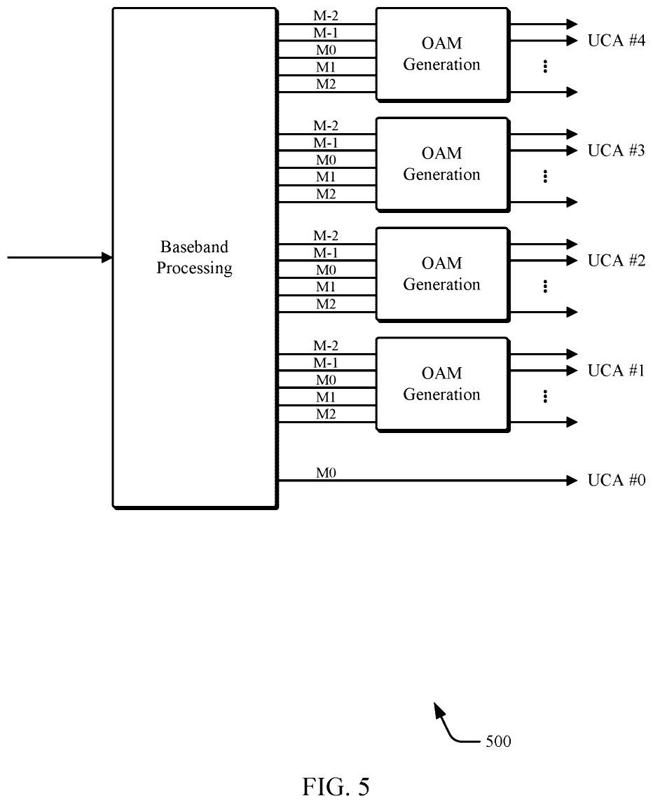

FIG. 5 illustrates an example 500 of streams generation corresponding to OAM modes for an UCA array, as related to OAM data channels configuration. Aspects of this disclosure provide for OAM-MIMO multiplexing with multiple antenna arrays generating OAM modes in parallel. Although the OAM mode order can be infinitely increased, higher OAM modes indices or order spatially diverge more with propagation distance, thus limiting the spatial multiplexing order for practical use. This issue can be resolved if MIMO is combined with OAM, referred to as OAM-MIMO herein. An example of such array is shown in example 400 in FIG. 4, where four UCAs are used with one centric element for symmetry. Each UCA can generate multiple OAM modes. For instance, if each UCA layer generates five (5) lower order OAM modes (e.g.,−2, −1, 0, 1, 2), then in total, twenty-one (21) streams can be generated simultaneously, thus increasing the spatial multiplexing order while addressing the divergence issue of higher OAM modes, as shown in this example 500, where M-2, M-1, MO, M1, M2 corresponds to spatial streams after baseband processing to be mapped on the OAM modes −2, −1, 0, 1, 2. By utilizing techniques of MIMO technology, it is possible to separate signals between multiple sets of the same OAM modes while maintaining non-interfering properties between the different OAM modes.

In an implementation of OAM-MIMO, a UE may receive the same OAM mode indices (one or multiple) that are spatially separated and correspond to multiple TCI states (beams). In an implementation, a UE may be indicated (configured) for the number of parallel arrays used for OAM generation. For example, the UE may be indicated through RRC signaling, where a group number or an index for each antenna array is specified. In an implementation, the number of arrays used for generating OAM modes in parallel would correspond to the number of TCI states. For example, in the example 500, a total of five (5) states may be configured to the UE, where each TCI state would correspond to an OAM mode order. In an implementation, the mode order would be the same for all TCI states, and only an indication of mode number for only one TCI state would be needed as it would be applicable to all the TCI states. For instance, if only the mode indices for data transmission and/or reception are indicated by either DCI or RRC, and no specific relationship to a TCI state is indicated, the UE would consider by default that these OAM modes are applicable to all TCI states. In an implementation for each TCI state, a list of configured OAM modes may be indicated through DCI, MAC CE, or RRC signalling, where each TCI state may or may not have the same number of OAM mode indices. In an implementation, an array generating only zero mode may be considered as a default setting and a specific TCI state may be specified for this mode.

In one or more implementations, one set of OAM modes is indicated, multiple TCI states are indicated, and rank 1/diversity transmission is indicated to the UE for DL reception and/or UL transmissions. In this implementation, multiple beams are deployed where each beam has multiple streams with OAM multiplexed data with the OAM modes defined in the set. Moreover, same TB (or code block group or codeword) are used for generating same OAM index that are generated by different arrays and are transmitted on the multiple beams corresponding to multiple antenna arrays. In one or more implementations, one set of OAM modes is indicated, and multiple TCI states are indicated with rank greater than or equal to two (rank>=2) spatial multiplexing transmission to the UE for DL reception and/or UL transmissions. In this implementation, multiple beams are deployed where each beam has multiple streams with OAM multiplexed data with the OAM modes defined in the set. Moreover, different TBs (or a code block group or a codeword) are used for generating a same OAM index that is generated by different arrays, and is transmitted on the multiple beams corresponding to multiple antenna arrays.

Aspects of this disclosure provide for DM-RS association for OAM multiplexing data channels. In one or more implementations, the DM-RS ports may be extended in the orbital angular domain, where the same or different DM-RS ports can be associated with OAM modes. In an implementation, the same DM-RS ports (or CDM groups) can be used for any of the following combinations: a same OAM mode index, same beam; different OAM mode indices, same beam; a same OAM mode index, different beams; and/or different OAM mode indices, different beams. In an implementation, the number of DM-RS antenna ports may be extended and may correspond to either a mode index and/or to a number of TCI states. In an implementation, when the same DM-RS ports are used for any one of the above cases, then more than one codeword can be transmitted when four (4) or less DM-RS ports are indicated to the UE using the antenna port(s) indication field in the DCI. In another implementation, if the same DM-RS ports are used for different OAM modes, initialization of the DM-RS base sequences can be different and associated with an OAM mode index.

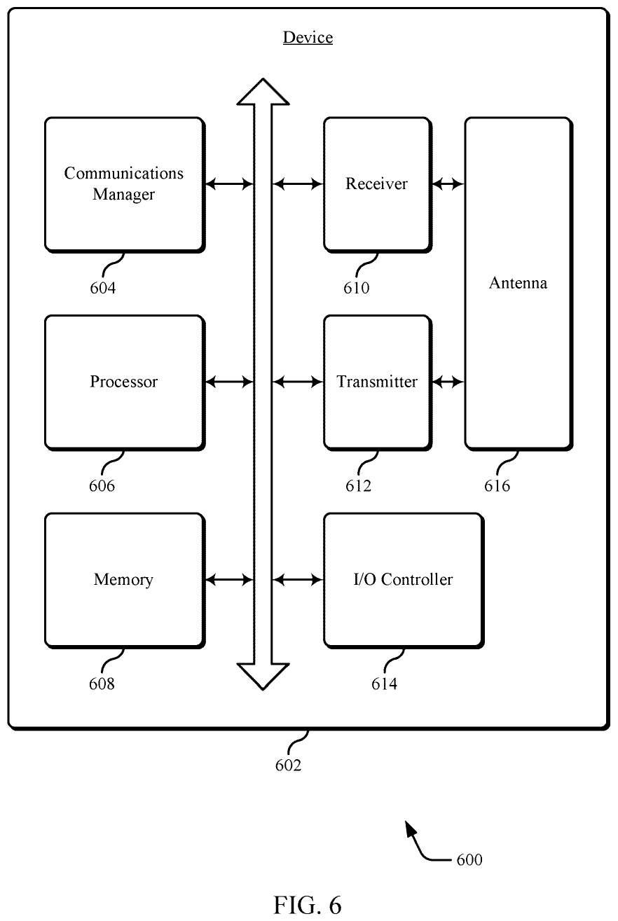

FIG. 6 illustrates an example of a block diagram 600 of a device 602 that supports OAM data channels configuration in accordance with aspects of the present disclosure. The device 602 may be an example of a UE 104 as described herein. The device 602 may support wireless communication and/or network signaling with one or more base stations 102, other UEs 104, network entities and devices, or any combination thereof. The device 602 may include components for bi-directional communications including components for transmitting and receiving communications, such as a communications manager 604, a processor 606, a memory 608, a receiver 610, a transmitter 612, and an I/O controller 614. These components may be in electronic communication or otherwise coupled (e.g., operatively, communicatively, functionally, electronically, electrically) via one or more interfaces (e.g., buses).

The communications manager 604, the receiver 610, the transmitter 612, or various combinations thereof or various components thereof may be examples of means for performing various aspects of the present disclosure as described herein. For example, the communications manager 604, the receiver 610, the transmitter 612, or various combinations or components thereof may support a method for performing one or more of the functions described herein.

In some implementations, the communications manager 604, the receiver 610, the transmitter 612, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 606 and the memory 608 coupled with the processor 606 may be configured to perform one or more of the functions described herein (e.g., by executing, by the processor 606, instructions stored in the memory 608).

Additionally or alternatively, in some implementations, the communications manager 604, the receiver 610, the transmitter 612, or various combinations or components thereof may be implemented in code (e.g., as communications management software or firmware) executed by the processor 606. If implemented in code executed by the processor 606, the functions of the communications manager 604, the receiver 610, the transmitter 612, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 604 may be configured to perform various operations (e.g., receiving, monitoring, transmitting) using or otherwise in cooperation with the receiver 610, the transmitter 612, or both. For example, the communications manager 604 may receive information from the receiver 610, send information to the transmitter 612, or be integrated in combination with the receiver 610, the transmitter 612, or both to receive information, transmit information, or perform various other operations as described herein. Although the communications manager 604 is illustrated as a separate component, in some implementations, one or more functions described with reference to the communications manager 604 may be supported by or performed by the processor 606, the memory 608, or any combination thereof. For example, the memory 608 may store code, which may include instructions executable by the processor 606 to cause the device 602 to perform various aspects of the present disclosure as described herein, or the processor 606 and the memory 608 may be otherwise configured to perform or support such operations.

For example, the communications manager 604 may support wireless communication and/or network signaling at a device (e.g., the device 602, a UE) in accordance with examples as disclosed herein. The communications manager 604 and/or other device components may be configured as or otherwise support an apparatus, such as a UE, including a transceiver; a processor coupled to the transceiver, the processor and the transceiver configured to cause the apparatus to: receive, from a base station, a signaling indicating an OAM multiplexing configuration of one or more configured OAM modes; and apply at least one of the configured OAM modes for at least one of receiving a downlink transmission or transmitting an uplink transmission.

Additionally, the apparatus (e.g., a UE) includes any one or combination of: the processor is configured to cause the apparatus to map the at least one configured OAM mode with at least one TCI for the at least one of receiving the downlink transmission or transmitting the uplink transmission. The processor is configured to cause the apparatus to apply a first configured OAM mode for the receiving the downlink transmission, and apply a second configured OAM mode for the transmitting the uplink transmission. A number of the one or more configured OAM modes is indicated by one of DCI signaling or RRC signaling. The OAM multiplexing configuration comprises a number of channel layers mapped to a number of codewords for spatial multiplexing, and the number of channel layers for each codeword is at least equal to a number of the one or more configured OAM modes. The number of channel layers indicates the number of the one or more configured OAM modes for the receiving the downlink transmission. The number of channel layers indicates the number of the one or more configured OAM modes for the transmitting the uplink transmission. The signaling indicating the OAM multiplexing configuration comprises a mapping matrix that maps a number of channel layers to the one or more configured OAM modes associated with utilizing spatial multiplexing. An index associated with the mapping matrix is indicated by at least one of DCI signaling, MAC CE signaling, or RRC signaling. The signaling indicating the OAM multiplexing configuration comprises a mapping matrix that maps a number of channel layers to the one or more configured OAM modes associated with utilizing a diversity scheme. An index associated with the mapping matrix is indicated by at least one of DCI signaling, MAC CE signaling, or RRC signaling. A number of TCI states corresponds to a number of the one or more configured OAM modes. A number of the one or more configured OAM modes corresponds to one TCI state. The signaling indicating the OAM multiplexing configuration comprises a number of the one or more configured OAM modes associated with respective TCI states that correspond to a set of antenna arrays. The TCI states indicates a number of the antenna arrays in the set of antenna arrays used for a same configured OAM mode indices generation. The signaling indicating the OAM multiplexing configuration indicates a set of OAM mode indices that is applicable to the TCI states. The signaling indicating the OAM multiplexing configuration indicates different sets of OAM mode indices applicable for the TCI states. The signaling indicating the OAM multiplexing configuration comprises a set of the one or more configured OAM modes, a set of the TCI states, and an indication of rank-two transmission for at least one of the receiving the downlink transmission or transmitting the uplink transmission. The signaling indicating the OAM multiplexing configuration comprises an association of DM-RS ports with the one or more configured OAM modes.

The communications manager 604 and/or other device components may be configured as or otherwise support a means for wireless communication and/or network signaling at a UE, including receiving a signaling indicating an OAM multiplexing configuration of one or more configured OAM modes; and applying at least one of the configured OAM modes for at least one of receiving a downlink transmission or transmitting an uplink transmission.

Additionally, wireless communication and/or network signaling at the UE includes any one or combination of: mapping the at least one configured OAM mode with at least one TCI for the at least one of receiving the downlink transmission or transmitting the uplink transmission. The method further comprising applying a first configured OAM mode for the receiving the downlink transmission; and applying a second configured OAM mode for the transmitting the uplink transmission. A number of the one or more configured OAM modes is indicated by one of DCI signaling or RRC signaling. The OAM multiplexing configuration comprises a number of channel layers mapped to a number of codewords for spatial multiplexing, and the number of channel layers for each codeword is at least equal to a number of the one or more configured OAM modes. The number of channel layers indicates the number of the one or more configured OAM modes for the receiving the downlink transmission. The number of channel layers indicates the number of the one or more configured OAM modes for the transmitting the uplink transmission. The signaling indicating the OAM multiplexing configuration comprises a mapping matrix that maps a number of channel layers to the one or more configured OAM modes associated with utilizing spatial multiplexing. An index associated with the mapping matrix is indicated by at least one of DCI signaling, MAC CE signaling, or RRC signaling. The signaling indicating the OAM multiplexing configuration comprises a mapping matrix that maps a number of channel layers to the one or more configured OAM modes associated with utilizing a diversity scheme. An index associated with the mapping matrix is indicated by at least one of DCI signaling, MAC CE signaling, or RRC signaling. A number of TCI states corresponds to a number of the one or more configured OAM modes. A number of the one or more configured OAM modes corresponds to one TCI state. The signaling indicating the OAM multiplexing configuration comprises a number of the one or more configured OAM modes associated with respective TCI states that correspond to a set of antenna arrays. A number of the TCI states indicates a number of the antenna arrays in the set of antenna arrays used for a same configured OAM mode indices generation. The signaling indicating the OAM multiplexing configuration indicates a set of OAM mode indices that is applicable to the TCI states. The signaling indicating the OAM multiplexing configuration indicates different sets of OAM mode indices applicable for the TCI states. The signaling indicating the OAM multiplexing configuration comprises a set of the one or more configured OAM modes, a set of the TCI states, and an indication of rank-two transmission for at least one of the receiving the downlink transmission or transmitting the uplink transmission. The signaling indicating the OAM multiplexing configuration comprises an association of demodulation reference signal (DM-RS) ports with the one or more configured OAM modes.

The processor 606 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 606 may be configured to operate a memory array using a memory controller. In some other implementations, a memory controller may be integrated into the processor 606. The processor 606 may be configured to execute computer-readable instructions stored in a memory (e.g., the memory 608) to cause the device 602 to perform various functions of the present disclosure.

The memory 608 may include random access memory (RAM) and read-only memory (ROM). The memory 608 may store computer-readable, computer-executable code including instructions that, when executed by the processor 606 cause the device 602 to perform various functions described herein. The code may be stored in a non-transitory computer-readable medium such as system memory or another type of memory. In some implementations, the code may not be directly executable by the processor 606 but may cause a computer (e.g., when compiled and executed) to perform functions described herein. In some implementations, the memory 608 may include, among other things, a basic I/O system (BIOS) which may control basic hardware or software operation such as the interaction with peripheral components or devices.

The I/O controller 614 may manage input and output signals for the device 602. The I/O controller 614 may also manage peripherals not integrated into the device 602. In some implementations, the I/O controller 614 may represent a physical connection or port to an external peripheral. In some implementations, the I/O controller 614 may utilize an operating system such as iOS®, ANDROID®, MS-DOS®, MS-WINDOWS®, OS/2®, UNIX®, LINUX®, or another known operating system. In some implementations, the I/O controller 614 may be implemented as part of a processor, such as the processor 606. In some implementations, a user may interact with the device 602 via the I/O controller 614 or via hardware components controlled by the I/O controller 614.

In some implementations, the device 602 may include a single antenna 616. However, in some other implementations, the device 602 may have more than one antenna 616, which may be capable of concurrently transmitting or receiving multiple wireless transmissions. The receiver 610 and the transmitter 612 may communicate bi-directionally, via the one or more antennas 616, wired, or wireless links as described herein. For example, the receiver 610 and the transmitter 612 may represent a wireless transceiver and may communicate bi-directionally with another wireless transceiver. The transceiver may also include a modem to modulate the packets, to provide the modulated packets to one or more antennas 616 for transmission, and to demodulate packets received from the one or more antennas 616.

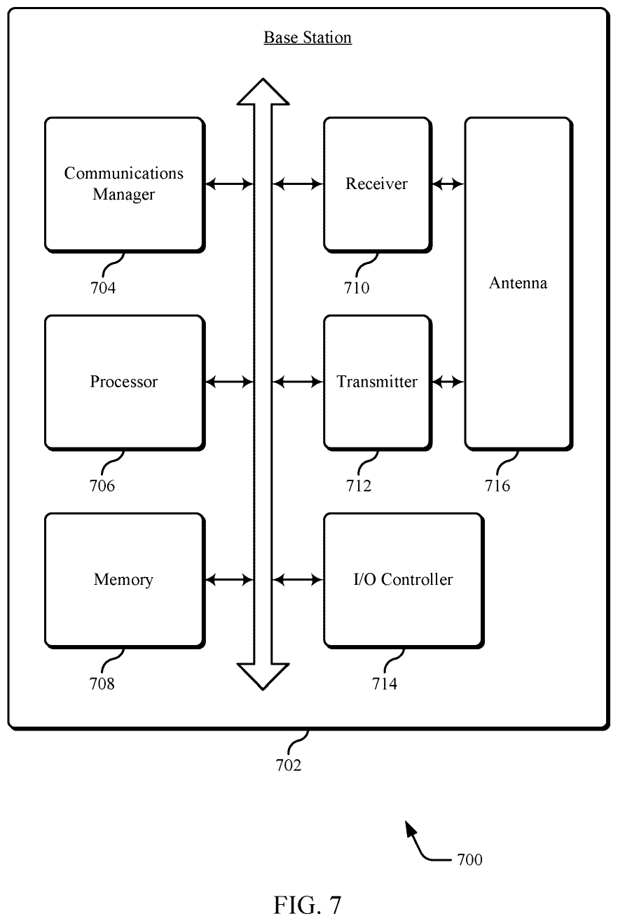

FIG. 7 illustrates an example of a block diagram 700 of a device 702 that supports OAM data channels configuration in accordance with aspects of the present disclosure. The device 702 may be an example of a base station 102 (e.g., a gNB) as described herein. The device 702 may support wireless communication and/or network signaling with one or more base stations 102, other UEs 104, core network devices and functions (e.g., core network 106), or any combination thereof. The device 702 may include components for bi-directional communications including components for transmitting and receiving communications, such as a communications manager 704, a processor 706, a memory 708, a receiver 710, a transmitter 712, and an I/O controller 714. These components may be in electronic communication or otherwise coupled (e.g., operatively, communicatively, functionally, electronically, electrically) via one or more interfaces (e.g., buses).

The communications manager 704, the receiver 710, the transmitter 712, or various combinations thereof or various components thereof may be examples of means for performing various aspects of the present disclosure as described herein. For example, the communications manager 704, the receiver 710, the transmitter 712, or various combinations or components thereof may support a method for performing one or more of the functions described herein.

In some implementations, the communications manager 704, the receiver 710, the transmitter 712, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 706 and the memory 708 coupled with the processor 706 may be configured to perform one or more of the functions described herein (e.g., by executing, by the processor 706, instructions stored in the memory 708).

Additionally or alternatively, in some implementations, the communications manager 704, the receiver 710, the transmitter 712, or various combinations or components thereof may be implemented in code (e.g., as communications management software or firmware) executed by the processor 706. If implemented in code executed by the processor 706, the functions of the communications manager 704, the receiver 710, the transmitter 712, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 704 may be configured to perform various operations (e.g., receiving, monitoring, transmitting) using or otherwise in cooperation with the receiver 710, the transmitter 712, or both. For example, the communications manager 704 may receive information from the receiver 710, send information to the transmitter 712, or be integrated in combination with the receiver 710, the transmitter 712, or both to receive information, transmit information, or perform various other operations as described herein.

Although the communications manager 704 is illustrated as a separate component, in some implementations, one or more functions described with reference to the communications manager 704 may be supported by or performed by the processor 706, the memory 708, or any combination thereof. For example, the memory 708 may store code, which may include instructions executable by the processor 706 to cause the device 702 to perform various aspects of the present disclosure as described herein, or the processor 706 and the memory 708 may be otherwise configured to perform or support such operations.

For example, the communications manager 704 may support wireless communication and/or network signaling at a device (e.g., the device 702, a base station) in accordance with examples as disclosed herein. The communications manager 704 and/or other device components may be configured as or otherwise support an apparatus, such as a base station, including a transceiver; a processor coupled to the transceiver, the processor and the transceiver configured to cause the apparatus to: transmit, to a UE, a signaling indicating an OAM multiplexing configuration of one or more configured OAM modes to be applied at the UE for at least one of receiving a downlink transmission or transmitting an uplink transmission; and receive, from the UE, the uplink transmission with at least one of the one or more configured OAM modes applied.

Additionally, the apparatus (e.g., a base station) includes any one or combination of: the signaling is transmitted to the UE to map the at least one configured OAM mode with at least one TCI for the at least one of receiving the downlink transmission or transmitting the uplink transmission. A number of the one or more configured OAM modes is indicated by one of DCI signaling or RRC signaling. The OAM multiplexing configuration comprises a number of channel layers mapped to a number of codewords for spatial multiplexing, and the number of channel layers for each codeword is at least equal to a number of the one or more configured OAM modes. The number of channel layers indicates the number of the one or more configured OAM modes for the UE receiving the downlink transmission. The number of channel layers indicates the number of the one or more configured OAM modes for the UE transmitting the uplink transmission. The signaling indicating the OAM multiplexing configuration comprises a mapping matrix that maps a number of channel layers to the one or more configured OAM modes associated with utilizing spatial multiplexing. An index associated with the mapping matrix is indicated by at least one of DCI signaling, MAC CE signaling, or RRC signaling. The signaling indicating the OAM multiplexing configuration comprises a mapping matrix that maps a number of channel layers to the one or more configured OAM modes associated with utilizing a diversity scheme. An index associated with the mapping matrix is indicated by at least one of DCI signaling, MAC CE signaling, or RRC signaling. A number of TCI states corresponds to a number of the one or more configured OAM modes. A number of the one or more configured OAM modes corresponds to one TCI state. The signaling indicating the OAM multiplexing configuration comprises a number of the one or more configured OAM modes associated with respective TCI states that correspond to a set of antenna arrays. The TCI states indicates a number of the antenna arrays in the set of antenna arrays used for a same configured OAM mode indices generation. The signaling indicating the OAM multiplexing configuration indicates a set of OAM mode indices that is applicable to the TCI states. The signaling indicating the OAM multiplexing configuration indicates different sets of OAM mode indices applicable for the TCI states. The signaling indicating the OAM multiplexing configuration comprises a set of the one or more configured OAM modes, a set of the TCI states, and an indication of rank-two transmission for at least one of the UE receiving the downlink transmission or the UE transmitting the uplink transmission. The signaling indicating the OAM multiplexing configuration comprises an association of DM-RS ports with the one or more configured OAM modes.

The communications manager 704 and/or other device components may be configured as or otherwise support a means for wireless communication and/or network signaling at a base station, including transmitting, to a UE, a signaling indicating an OAM multiplexing configuration of one or more configured OAM modes to be applied at the UE for at least one of receiving a downlink transmission or transmitting an uplink transmission; and receiving, from the UE, the uplink transmission with at least one of the one or more configured OAM modes applied.

Additionally, wireless communication at the base station includes any one or combination of: the signaling is transmitted to the UE to map the at least one configured OAM mode with at least one TCI for the at least one of receiving the downlink transmission or transmitting the uplink transmission. A number of the one or more configured OAM modes is indicated by one of DCI signaling or RRC signaling. The OAM multiplexing configuration comprises a number of channel layers mapped to a number of codewords for spatial multiplexing, and the number of channel layers for each codeword is at least equal to a number of the one or more configured OAM modes. The number of channel layers indicates the number of the one or more configured OAM modes for the UE receiving the downlink transmission. The number of channel layers indicates the number of the one or more configured OAM modes for the UE transmitting the uplink transmission. The signaling indicating the OAM multiplexing configuration comprises a mapping matrix that maps a number of channel layers to the one or more configured OAM modes associated with utilizing spatial multiplexing. An index associated with the mapping matrix is indicated by at least one of DCI signaling, MAC CE signaling, or RRC signaling. The signaling indicating the OAM multiplexing configuration comprises a mapping matrix that maps a number of channel layers to the one or more configured OAM modes associated with utilizing a diversity scheme. An index associated with the mapping matrix is indicated by at least one of DCI signaling, MAC CE signaling, or RRC signaling. A number of TCI states corresponds to a number of the one or more configured OAM modes. A number of the one or more configured OAM modes corresponds to one TCI state. The signaling indicating the OAM multiplexing configuration comprises a number of the one or more configured OAM modes associated with respective TCI states that correspond to a set of antenna arrays. A number of the TCI states indicates a number of the antenna arrays in the set of antenna arrays used for a same configured OAM mode indices generation. The signaling indicating the OAM multiplexing configuration indicates a set of OAM mode indices that is applicable to the TCI states. The signaling indicating the OAM multiplexing configuration indicates different sets of OAM mode indices applicable for the TCI states. The signaling indicating the OAM multiplexing configuration comprises a set of the one or more configured OAM modes, a set of the TCI states, and an indication of rank-two transmission for at least one of the UE receiving the downlink transmission or the UE transmitting the uplink transmission. The signaling indicating the OAM multiplexing configuration comprises an association of DM-RS ports with the one or more configured OAM modes.

The processor 706 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 706 may be configured to operate a memory array using a memory controller. In some other implementations, a memory controller may be integrated into the processor 706. The processor 706 may be configured to execute computer-readable instructions stored in a memory (e.g., the memory 708) to cause the device 702 to perform various functions of the present disclosure.

The memory 708 may include random access memory (RAM) and read-only memory (ROM). The memory 708 may store computer-readable, computer-executable code including instructions that, when executed by the processor 706 cause the device 702 to perform various functions described herein. The code may be stored in a non-transitory computer-readable medium such as system memory or another type of memory. In some implementations, the code may not be directly executable by the processor 706 but may cause a computer (e.g., when compiled and executed) to perform functions described herein. In some implementations, the memory 708 may include, among other things, a basic I/O system (BIOS) which may control basic hardware or software operation such as the interaction with peripheral components or devices.

The I/O controller 714 may manage input and output signals for the device 702. The I/O controller 714 may also manage peripherals not integrated into the device 702. In some implementations, the I/O controller 714 may represent a physical connection or port to an external peripheral. In some implementations, the I/O controller 714 may utilize an operating system such as iOS®, ANDROID®, MS-DOS®, MS-WINDOWS®, OS/2®, UNIX®, LINUX®, or another known operating system. In some implementations, the I/O controller 714 may be implemented as part of a processor, such as the processor 706. In some implementations, a user may interact with the device 702 via the I/O controller 714 or via hardware components controlled by the I/O controller 714.

In some implementations, the device 702 may include a single antenna 716. However, in some other implementations, the device 702 may have more than one antenna 716, which may be capable of concurrently transmitting or receiving multiple wireless transmissions. The receiver 710 and the transmitter 712 may communicate bi-directionally, via the one or more antennas 716, wired, or wireless links as described herein. For example, the receiver 710 and the transmitter 712 may represent a wireless transceiver and may communicate bi-directionally with another wireless transceiver. The transceiver may also include a modem to modulate the packets, to provide the modulated packets to one or more antennas 716 for transmission, and to demodulate packets received from the one or more antennas 716.

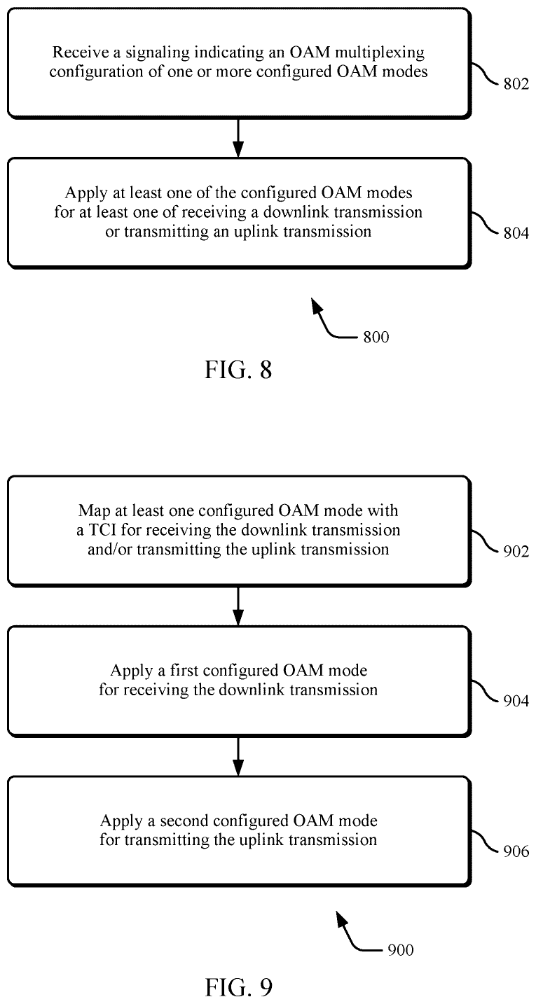

FIG. 8 illustrates a flowchart of a method 800 that supports OAM data channels configuration in accordance with aspects of the present disclosure. The operations of the method 800 may be implemented and performed by a device or its components, such as a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 802, the method may include receiving a signaling indicating an OAM multiplexing configuration of one or more configured OAM modes. The operations of 802 may be performed in accordance with examples as described herein. In some implementations, aspects of the operations of 802 may be performed by a device as described with reference to FIG. 1.

At 804, the method may include applying at least one of the configured OAM modes for at least one of receiving a downlink transmission or transmitting an uplink transmission. The operations of 804 may be performed in accordance with examples as described herein. In some implementations, aspects of the operations of 804 may be performed by a device as described with reference to FIG. 1.

FIG. 9 illustrates a flowchart of a method 900 that supports OAM data channels configuration in accordance with aspects of the present disclosure. The operations of the method 900 may be implemented and performed by a device or its components, such as a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 902, the method may include mapping at least one configured OAM mode with a TCI for receiving the downlink transmission and/or transmitting the uplink transmission. The operations of 902 may be performed in accordance with examples as described herein. In some implementations, aspects of the operations of 902 may be performed by a device as described with reference to FIG. 1.

At 904, the method may include applying a first configured OAM mode for receiving the downlink transmission. The operations of 904 may be performed in accordance with examples as described herein. In some implementations, aspects of the operations of 904 may be performed by a device as described with reference to FIG. 1.

At 906, the method may include applying a second configured OAM mode for transmitting the uplink transmission. The operations of 906 may be performed in accordance with examples as described herein. In some implementations, aspects of the operations of 906 may be performed by a device as described with reference to FIG. 1.

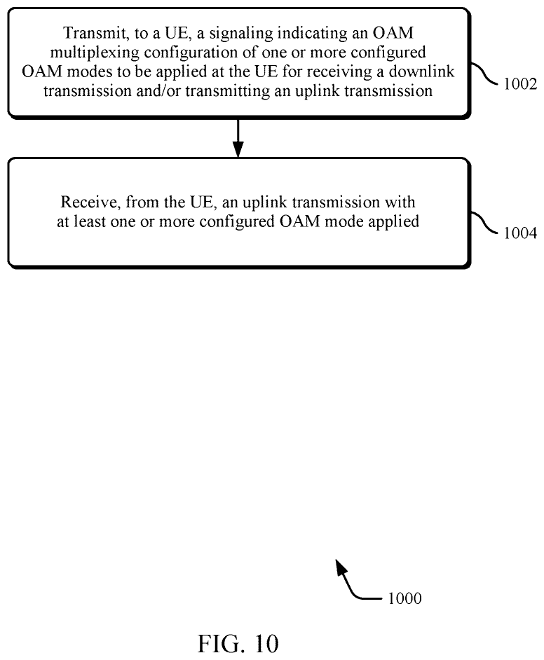

FIG. 10 illustrates a flowchart of a method 1000 that supports OAM data channels configuration in accordance with aspects of the present disclosure. The operations of the method 1000 may be implemented and performed by a device or its components, such as a base station 102 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1002, the method may include transmitting, to a UE, a signaling indicating an OAM multiplexing configuration of one or more configured OAM modes to be applied at the UE for receiving a downlink transmission and/or transmitting an uplink transmission. The operations of 1002 may be performed in accordance with examples as described herein. In some implementations, aspects of the operations of 1002 may be performed by a device as described with reference to FIG. 1.

At 1004, the method may include receiving, from the UE, an uplink transmission with at least one or more configured OAM mode applied. The operations of 1004 may be performed in accordance with examples as described herein. In some implementations, aspects of the operations of 1004 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined.

The order in which the methods are described is not intended to be construed as a limitation, and any number or combination of the described method operations may be performed in any order to perform a method, or an alternate method.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C, or AB or AC or BC, or ABC (i.e., A and B and C). Similarly, a list of one or more of A, B, or C means A or B or C, or AB or AC or BC, or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
receive, from a base station, a signaling indicating an orthogonal angular momentum (OAM) multiplexing configuration of one or more configured OAM modes; and
apply at least one of the configured OAM modes for at least one of receiving a downlink transmission or transmitting an uplink transmission.

2. The UE of claim 1, wherein the at least one processor is configured to cause the UE to map the at least one configured OAM mode with at least one transmission configuration indicator (TCI) for the at least one of receiving the downlink transmission or transmitting the uplink transmission.

3. The UE of claim 1, wherein the at least one processor is configured to cause the UE to apply a first configured OAM mode for the receiving the downlink transmission, and apply a second configured OAM mode for the transmitting the uplink transmission.

4. The UE of claim 1, wherein a number of the one or more configured OAM modes is indicated by one of downlink control information (DCI) signaling or radio resource control (RRC) signaling.

5. The UE of claim 1, wherein the OAM multiplexing configuration comprises a number of channel layers mapped to a number of codewords for spatial multiplexing, the number of channel layers for each codeword is at least equal to a number of the one or more configured OAM modes, and the number of channel layers indicates the number of the one or more configured OAM modes for at least one of the receiving the downlink transmission or the transmitting the uplink transmission.

6. The UE of claim 1, wherein the signaling indicating the OAM multiplexing configuration comprises a mapping matrix that maps a number of channel layers to the one or more configured OAM modes associated with utilizing at least one of spatial multiplexing or a diversity scheme.

7. The UE of claim 1, wherein a number of transmission configuration indicator (TCI) states corresponds to a number of the one or more configured OAM modes.

8. The UE of claim 1, wherein a number of the one or more configured OAM modes corresponds to one transmission configuration indicator (TCI) state.

9. The UE of claim 1, wherein the signaling indicating the OAM multiplexing configuration comprises a number of the one or more configured OAM modes associated with respective transmission configuration indicator (TCI) states that correspond to a set of antenna arrays.

10. The UE of claim 1, wherein the signaling indicating the OAM multiplexing configuration comprises an association of demodulation reference signal (DM-RS) ports with the one or more configured OAM modes.

11. A method performed by a user equipment (UE), the method comprising:
receiving a signaling indicating an orthogonal angular momentum (OAM) multiplexing configuration of one or more configured OAM modes; and
applying at least one of the configured OAM modes for at least one of receiving a downlink transmission or transmitting an uplink transmission.

12-15. (canceled)

16. A base station for wireless communication, comprising:
at least one memory; and
at least one processor coupled with the at least one memory and configured to cause the base station to:
transmit, to a user equipment (UE), a signaling indicating an orthogonal angular momentum (OAM) multiplexing configuration of one or more configured OAM modes to be applied at the UE for at least one of receiving a downlink transmission or transmitting an uplink transmission; and
receive, from the UE, the uplink transmission with at least one of the one or more configured OAM modes applied.

17. The base station of claim 16, wherein the signaling is transmitted to the UE to map the at least one configured OAM mode with at least one transmission configuration indicator (TCI) for the at least one of receiving the downlink transmission or transmitting the uplink transmission.

18. The base station of claim 16, wherein a number of the one or more configured OAM modes is indicated by one of downlink control information (DCI) signaling or radio resource control (RRC) signaling.

19. The base station of claim 16, wherein the OAM multiplexing configuration comprises a number of channel layers mapped to a number of codewords for spatial multiplexing, the number of channel layers for each codeword is at least equal to a number of the one or more configured OAM modes, and the number of channel layers indicates the number of the one or more configured OAM modes for at least one of the UE receiving the downlink transmission or the UE transmitting the uplink transmission.

20. The base station of claim 16, wherein the signaling indicating the OAM multiplexing configuration comprises a mapping matrix that maps a number of channel layers to the one or more configured OAM modes associated with utilizing at least one of spatial multiplexing or a diversity scheme.

21. A processor for wireless communication, comprising:
at least one controller coupled with at least one memory and configured to cause the processor to:
receive, from a base station, a signaling indicating an orthogonal angular momentum (OAM) multiplexing configuration of one or more configured OAM modes; and
apply at least one of the configured OAM modes for at least one of receiving a downlink transmission or transmitting an uplink transmission.

22. The processor of claim 21, wherein the at least one controller is configured to cause the processor to map the at least one configured OAM mode with at least one transmission configuration indicator (TCI) for the at least one of receiving the downlink transmission or transmitting the uplink transmission.

23. The processor of claim 21, wherein the at least one controller is configured to cause the processor to apply a first configured OAM mode for the receiving the downlink transmission, and apply a second configured OAM mode for the transmitting the uplink transmission.

24. The processor of claim 21, wherein a number of the one or more configured OAM modes is indicated by one of downlink control information (DCI) signaling or radio resource control (RRC) signaling.
